(19) United States
(12) Patent Application Publication
(10) Pub. No.: US 2022/0237253 A1
(43) Pub. Date: Jul. 28, 2022

(54) INFORMATION PROCESSING SYSTEM, CONTROL METHOD, AND STORAGE MEDIUM

(71) Applicants: CANON MARKETING JAPAN KABUSHIKI KAISHA, Tokyo (JP); CANON IT SOLUTIONS KABUSHIKI KAISHA, Tokyo (JP)

(72) Inventors: Tomoko Ishida, Tokyo (JP); Go Takatsuka, Tokyo (JP)

(21) Appl. No.: 17/580,189

(22) Filed: Jan. 20, 2022

(30) Foreign Application Priority Data
Jan. 22, 2021 (JP) 2021-008957
Nov. 29, 2021 (JP) 2021-192811

(51) Int. Cl. G06F 16/955; G06F 16/957

(52) U.S. Cl. CPC G06F 16/9566; G06F 16/9577; G06F 16/9562

(57) ABSTRACT

An information processing system displays a display item accepting an instruction about whether to provide identification information for a screen displayed by generated application software. The information processing device generates specific application software operable to display a first screen on which an instruction to provide identification information is accepted by the display item and a second screen on which an instruction to provide identification information is not accepted, the specific application software being application software based on the instruction for the display item. When the specific application software is executed, identification information of the first screen for providing an instruction to display the first screen is output to a user, and identification information of the second screen for providing an instruction to display the second screen is not output to the user.

### BACKGROUND

### Field of the Disclosure

The present disclosure relates to an information processing device, an information processing method, and a storage medium that generate application software.

### Description of the Related Art

Recently, a single-page application (SPA) that can return a high-speed response to a user and provide an excellent UI/UX is in practical use. The single-page application is characterized by achieving screen drawing while making dynamic changes to one sheet of HTML by using JavaScript; and in the single-page application, an entire page is loaded only for the first time, and only a required part is reloaded by receiving JSON data from a server from the second time onward. The need for generating a screen on the server side is eliminated, and a system on which application software runs with a minimum amount of data transfer can be built; and therefore a waiting time on the user side decreases, thus leading to user satisfaction.

On the other hand, the single-page application has a problem that when a UI transitions from a page initially transmitted to a client to the next page, the URI remains the same due to being a single page and every screen has the same URI.

Therefore, bookmarking any screen being a transition destination in the single-page application is not achievable; and in order to transition to the screen, the same transition from the initial display screen always needs to be followed, otherwise the target screen cannot be displayed.

In order to solve the problem described above, there is a technology called routing in the single-page application for setting any URI for each screen.

Japanese Patent Application Publication No. 2017-220221 describes an invention resolving a difficulty of developing a single-page application when a transition relation or the like between various screens for using a web application is complex.

However, from a viewpoint of a developer developing a single-page application, when a URI is associated with every transitioning UI by the routing technology, it is inconvenient when there is a UI (screen) to which a direct transition by a user of the application software by using a URI is undesirable.

For example, in a case of application software in which screen transition such as an input screen→a confirmation screen of the input content→a selection screen of a person in charge of application (approver) is made, it is undesirable to allow a user of the application software to directly transition to or bookmark the confirmation screen of the input content by using a URI.

When association with any URI by routing is performed, a complex routing setting needs to be made in order to generate a single-page application in which both a screen to which a direct transition is allowed by using a URI and a screen to which a direct transition is not allowed are mixed, which is difficult work for a developer.

### SUMMARY OF THE DISCLOSURE

An aspect of the present disclosure provides a mechanism for easily generating application software in which a screen to which a direct transition is allowed and a screen to which a direct transition is not allowed coexist.

According to one aspect of the present disclosure, an information processing system comprises at least one memory and at least one processor which function as:

a display control unit configured to perform control to display a display item accepting an instruction about whether to provide identification information for a screen displayed by generated application software; and

a control unit configured to perform control to generate application software based on the instruction accepted for the display item,

wherein the control unit is operable to generate specific application software, and

wherein the specific application software is operable to display a first screen on which an instruction to provide identification information is accepted by the display item and a second screen on which an instruction to provide identification information is not accepted by the display item, and wherein, when the specific application software is executed, the specific application software operates to output, to a user of the specific application software, identification information of the first screen for providing an instruction to display the first screen and not to output, to the user, identification information of the second screen for providing an instruction to display the second screen.

Further features of various embodiments will become apparent from the following description of exemplary embodiments (with reference to the attached drawings).

### BRIEF DESCRIPTION OF THE DRAWINGS

FIG. 1 is a system configuration diagram according to an embodiment.

FIG. 2 is a hardware block diagram of a program development device, an execution server, a database server, and a client PC according to the present embodiment.

FIG. 3 is a functional block diagram of software in the program development device according to the present embodiment.

FIG. 4 is a functional configuration diagram of a system according to the present embodiment.

FIG. 5 is a flowchart of web application generation processing according to the present embodiment.

FIG. 6 is a flowchart of routing setting processing according to the present embodiment.

FIG. 7 is a screen display example displayed on an output unit 210 according to the present embodiment.

FIG. 8 is a screen display example displayed on the output unit 210 according to the present embodiment.

FIG. 9 is an example of a routing setting file according to the present embodiment.

FIG. 10 is a screen display example displayed on the output unit 210 according to the present embodiment.

### DESCRIPTION OF THE EMBODIMENTS

An embodiment of the present disclosure is described in detail below with reference to drawings.

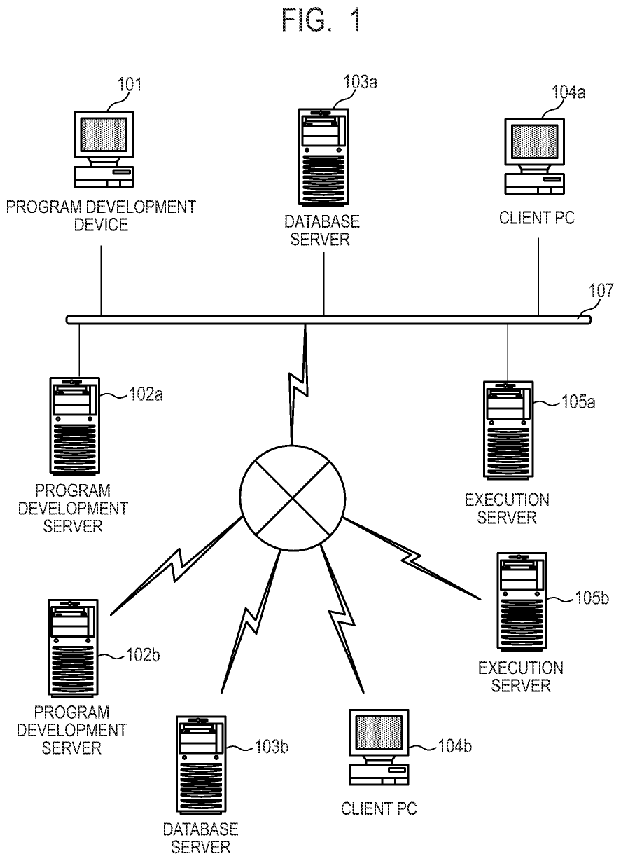

FIG. 1 is a system (information processing system) configuration diagram illustrating a configuration example of a program development device (an information processing device used for generation of a web application by a developer), a program development server, a database server, a client PC (client device), an execution server, and a web server according to the present disclosure.

A program development device 101 defines a screen layout, a database search instruction, and the like in accordance with a developer operation. Note that roles may be shared in such a way that the program development device 101 accepts developer input and a program development server 102 described later performs actual program generation processing and application generation processing (generation processing of application software), or the program development device 101 may singly perform up to the program generation and the application software generation.

While it is assumed in the present embodiment that application software generated by the program development device 101 is a web application, the application software is not limited to the above and may be application software, built-in software, or the like operating on an information processing device such as a mobile phone, a smartphone, or a tablet that are not application software using communication by a web technology.

Further, while it is assumed in the present embodiment that a program for application software is generated by the program development device 101, an environment in which application software operates may be constructed by using a definition set in accordance with a developer operation, without being limited to generation of a program.

Each of program development servers 102a and 102b (information processing devices) generates a program in accordance with a setting and an instruction by a developer input through the program development device 101. The program development server 102a may be placed in a network 107 such as a LAN, and the program development server 102b may be placed on the Internet or a cloud.

Each of database servers 103a and 103b (information processing devices) is a database used by developed application software and may also be used for validation or the like during development in the present disclosure. For example, the database server 103 may be configured with the same device as the program development device 101 for use by a developer or may be placed in the network 107 such as a LAN (the database server 103a). Further, the database server 103 may be placed on the Internet or a cloud (the database server 103b). Further, when the program development device 101 operates in coordination with the program development server 102, the program development server 102 and the database server 103 may be configured in the same device.

An execution server 105 (information processing device) executes an application program generated by the program development device 101 (a program of application software generated by the program development device 101). The execution server 105 may be placed in the network 107 such as a LAN (an execution server 105a) or may be placed on the Internet or a cloud (an execution server 105b). Further, the execution server 105 may be connected to and operate with the database server 103 in the network 107, or on the Internet or a cloud.

Each of client PCs 104a and 104b (information processing devices) is a user input terminal for operating, in coordination with the execution server 105, an application program developed by the program development device 101. The client PC 104 may be placed in the network 107 such as a LAN (a client PC 104a) or may be placed on the Internet or a cloud (a client PC 104b). The client PC 104 may be an information processing device such as a mobile terminal.

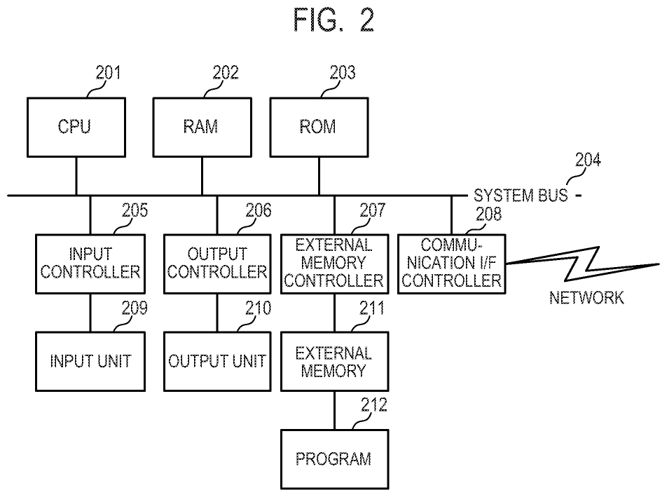

FIG. 2 is a block diagram illustrating an example of a hardware configuration applicable as the program development device 101, the execution server 105, the database server 103, and the client PC 104 according to the present disclosure.

In FIG. 2, a CPU 201 is at least one processor and centrally controls devices connected to a system bus 204.

Further, a ROM 203 or an external memory 211 stores an operating system (OS) being a control program of the CPU 201 and a program for achieving various functionalities of the information processing devices, to be described later, such as the servers, the client, and the device.

A RAM 202 functions as a main memory, a work area, a temporary save area, and the like of the CPU 201.

An input controller 205 is configured to control input from an input unit 209. Examples of the input unit 209 in the information processing device include a keyboard, a pointing device such as a mouse, and a touch panel.

When the input unit 209 is a touch panel, it is assumed that a user can provide various instructions by depressing (touching with a finger or the like) an icon, a cursor, or a button displayed on the touch panel.

Further, the touch panel may be a touch panel such as a multi-touch screen that can detect positions touched by a plurality of fingers.

An output controller 206 is configured to control display by an output unit 210. Examples of the output unit 210 include a CRT and a liquid crystal display. A display on a notebook PC integrated into the main body is also included. Further, a projector may also be included.

An external memory controller 207 is configured to control access to the external memory 211 storing a boot program, various types of application software, font data, a user file, an edit file, a printer driver, and the like. The external memory 211 stores various tables and parameters for achieving various functionalities of the servers, the client, the device, and the like. Examples of the external memory 211 include a hard disk (HD), a flexible disk (FD), a compact flash (registered trademark) connected to a PCMCIA card slot through an adaptor, and a smart medium.

For example, the CPU 201 allows display on the output unit 210 by executing outline font expansion (rasterization) processing into a display information area in the RAM 202. Further, the CPU 201 allows a developer instruction by an unillustrated mouse cursor or the like on the output unit 210.

A communication I/F controller 208 is configured to execute communication control processing with external equipment through a network. For example, communication using TCP/IP can be executed.

A program 212 for achieving the present disclosure is recorded in the external memory 211 and is executed by the CPU 201 by being loaded into the RAM 202 as needed.

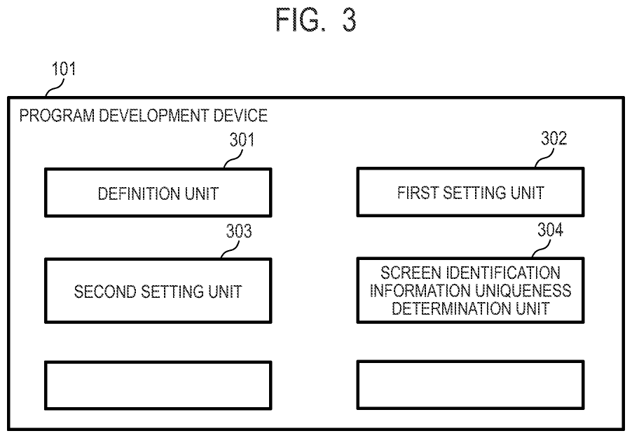

FIG. 3 is an example of a block diagram illustrating a software configuration according to the embodiment of the present disclosure.

The program development device 101 includes the following functional units.

A definition unit 301 is a functional unit configured to accept, from a developer, screen definition information such as a screen displayed by application software and placement of items (input-output items), and screen transition definition information defining a procedure of transition from a screen in the application software to the next screen.

A first setting unit 302 is a functional unit configured to accept, from a user, an input about whether to provide a screen code for identifying a screen in the screen definition information as a destination URI in a single-page application. A single-page application includes a routing library rendering (associating, correlating) a destination URI of page transition with a screen; and a UI screen accepted, by the first setting unit 302, to be provided with a screen code as a destination URI can display a screen directly rendered by a URI set in the following second setting unit.

While a location of a single-page application is specified by a URI in the present disclosure, any identification information for uniquely identifying a resource may be used, without being limited to a URI. Further, while a single-page application is described in the present disclosure, a single-page application does not necessarily need to be used, and any application software allowing switching and display of screens by using a single URI may be used.

A second setting unit 303 is a functional unit configured to provide a URI of a single-page application with a screen code accepted, by the first setting unit, to be provided. With screen codes provided by the second setting unit, URIs can be provided for a plurality of UI screens screen-transitioning in the single-page application, and a direct transition to a UI screen provided with a screen code is allowed even in a single-page application.

A screen identification information uniqueness determination unit 304 determines whether a screen code is unique. A case of a screen code not being unique in application software is determined to be a program generation error in consideration of possible URI duplication.

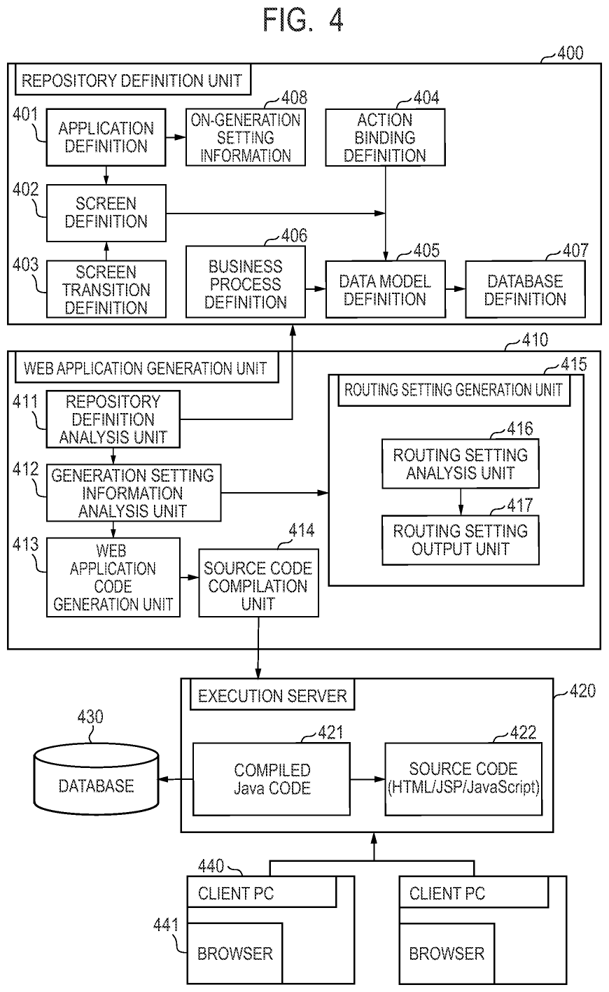

FIG. 4 is a configuration diagram of the program development device 101, the execution server 105, and the client PC 104.

The program development device 101 includes a repository definition unit 400 and a web application generation unit 410.

The execution server 105 corresponds to an execution server 420 in FIG. 4, and the client PC 104 corresponds to a client PC 440.

The program development device 101 generates a compiled Java (registered trademark) code 421 and a source code 422 (including a single-page application) such as HTML/JSP/JavaScript (registered trademark) by the web application generation unit 410.

The repository definition unit 400 includes an application definition 401, a screen definition 402, a screen transition definition 403, an action binding definition 404, a data model definition 405, a business process definition 406, a database definition 407, and an on-generation setting information 408. Information of the repository definition unit 400 is stored in the external memory 211.

The application definition 401 holds a setting of the entire application software developed by a developer. A definition of whether application software is to be a single-page application is also registered in the definition.

The screen definition 402 holds definition information of layouts of various items placed on an application software screen and includes input item definition information and output item definition information. The input item definition information is information defining an input item input by an end user of generated application software through a screen of the application software. The output item definition information is information defining an output item output to a screen of the generated application software. The input item and the output item are hereinafter collectively referred to as input-output items. Further, the definition 402 also includes information about the screen transition definition 403 defining transition information between screens.

The action binding definition 404 defines management of a source as a data acquisition source for acquiring data from an external site, a conversion method of acquired data, and the like.

The data model definition 405 holds definition information of an item in a database table. An item in the data model definition 405 can be associated with each of the input-output items in the screen definition 402.

The business process definition 406 holds definition information of logic for processing data in the application software.

The database definition 407 defines information related to a database connected to the application software (such as an IP address, a connected user, and a connection password of the database server 103).

The on-generation setting information 408 holds whether to provide a screen code acquired by the first setting unit 302 as a destination URI (whether to generate a routing setting) and the provided URI information when the screen code is provided.

The repository definition unit is an example of a means for storing a definition of application software to be generated.

The web application generation unit 410 is configured to analyze the repository definition unit 400 set by a developer and generates a web application (including a single-page application) including a compiled Java (registered trademark) code 421 and a source code 422.

A repository definition analysis unit 411 analyzes the repository definition unit 400 set by a developer.

A generation setting information analysis unit 412 is configured to acquire, from the on-generation setting information 408, whether to provide a screen code as a destination URI (whether to generate a routing setting) and makes a request to the routing setting generation unit 415 for processing when a routing setting is to be generated.

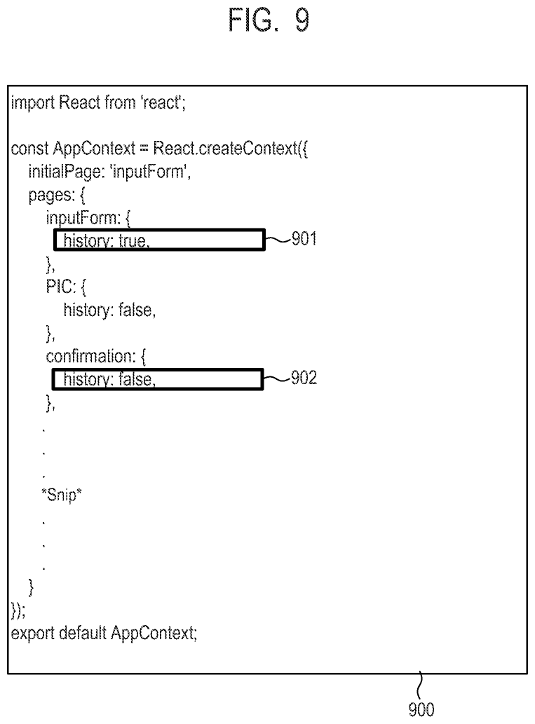

The routing setting generation unit 415 includes a routing setting analysis unit 416 and a routing setting output unit 417. The routing setting generation unit 415 is configured to analyze screen definition information from information from the generation setting information analysis unit 412 and the screen definition 402, by the routing setting analysis unit 416. The routing setting output unit 417 is configured to output a routing setting file, based on an analysis by the routing setting analysis unit 416. An example of a routing setting file is described later in FIG. 9.

A web application code generation unit 413 is configured to generate a source code of application software by using a code generation rule stored in the external memory 211 and contents analyzed by the repository definition analysis unit 411 and the generation setting information analysis unit 312.

A source code compilation unit 414 is configured to compile a source code generated by the web application code generation unit 413 and deploy a compiled Java (registered trademark) code 421 and a source code 422 including a single-page application and a routing setting file on the execution server 420.

The execution server 420 stores a web application including a compiled Java (registered trademark) code 421 and a source code 422 generated by the web application generation unit 410 and launches the web application.

The client PC 440 downloads a single-page application by specifying the URI of the execution server 420 from a web browser 441, accepts user operation on the web browser 441, and executes a generated web application.

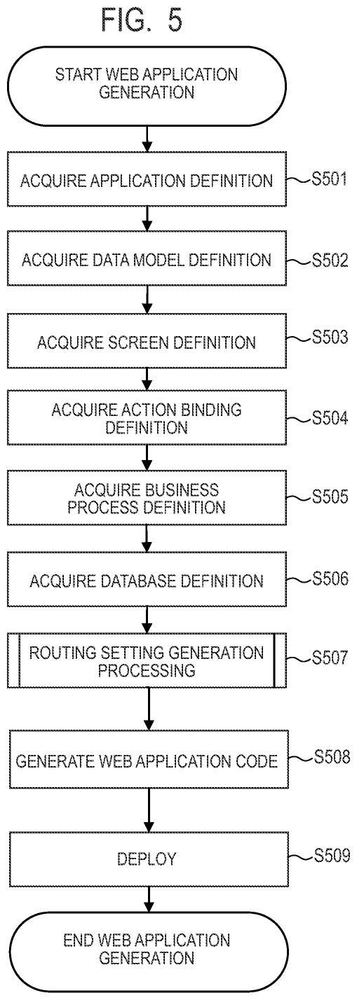

FIG. 5 is a diagram illustrating an example of a flowchart of web application generation. Note that each step in the following flowchart is executed by the CPU 201 in the program development device 101.

The flowchart in FIG. 5 is a flow of processing started in the program development device 101 when a developer generates a web application after defining each definition in the repository definition unit 400. Specific processing in each step is described below.

First, in Step S501, the CPU 201 in the program development device 101 reads the application definition 401 in the repository definition unit 400 stored in the external memory 211 into the RAM 202.

Next, in Step S502, the CPU 201 in the program development device 101 reads the data model definition 405 in the repository definition unit 400 stored in the external memory 211 into the RAM 202.

In Step S503, the CPU 201 in the program development device 101 reads the screen definition 402 in the repository definition unit 400 stored in the external memory 211 into the RAM 202. The CPU 201 performs screen generation in Step S508 with reference to the read screen definition 402. The same applies to the following processing.

In Step S504, the CPU 201 in the program development device 101 reads the action binding definition 404 in the repository definition unit 400 stored in the external memory 211 into the RAM 202.

In Step S505, the CPU 201 in the program development device 101 reads the business process definition 406 in the repository definition unit 400 stored in the external memory 211 into the RAM 202.

In Step S506, the CPU 201 in the program development device 101 reads the database definition 407 in the repository definition unit 400 stored in the external memory 211 into the RAM 202.

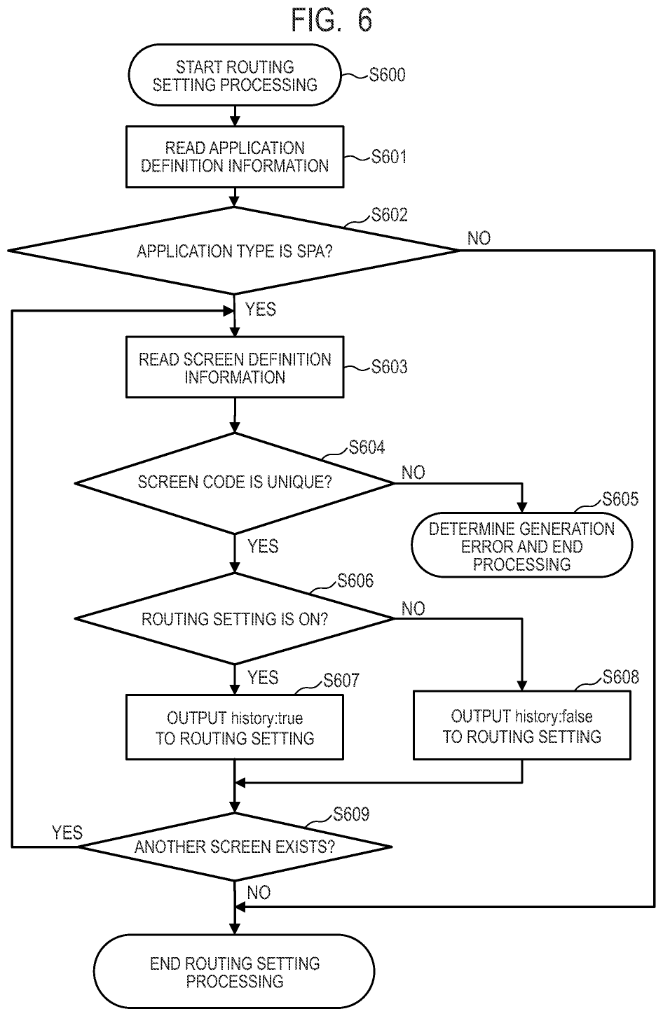

In Step S507, the CPU 201 in the program development device 101 generates a routing setting of a single-page application. For example, a routing setting file as illustrated in FIG. 9 is generated in Step S507. Details of Step S507 are described later with reference to FIG. 6.

In Step S508, the CPU 201 in the program development device 101 acquires information from each definition and each file in the repository definition unit 400 read into the RAM 202 and generates a source code of application software.

The generated source code includes application software such as HTML, JSP, and JavaScript (registered trademark), a single-page application used in the present disclosure, and the routing setting file (FIG. 9) generated in Step S507, in addition to a file in which a programming language is described.

In Step S509, the CPU 201 in the program development device 101 places (deploys) the application program group generated in Step S508 on the execution server 105. Thus, the application operates on the execution server 105.

The above concludes the description of the flowchart in FIG. 5.

Next, details of the processing in Step S507 is described with reference to FIG. 6.

FIG. 6 is a diagram illustrating an example of a flowchart illustrating a flow of routing setting processing during web application generation. Note that each step in the following flowchart is executed by the CPU 201 in each device.

The flowchart in FIG. 6 is a flow of processing started when the processing transitions to Step S507 in the flowchart in FIG. 5.

First, in Step S601, the CPU 201 in the program development device 101 reads the application definition 401 into the RAM 202.

Next, in Step S602, the CPU 201 in the program development device 101 branches the processing, based on information of the application definition 401 acquired in Step S601. The CPU 201 transitions the processing to Step S603 when the application software is registered to be generated as a single-page application and ends the processing in the flowchart in FIG. 6 when the application software is registered not to be generated as a single-page application.

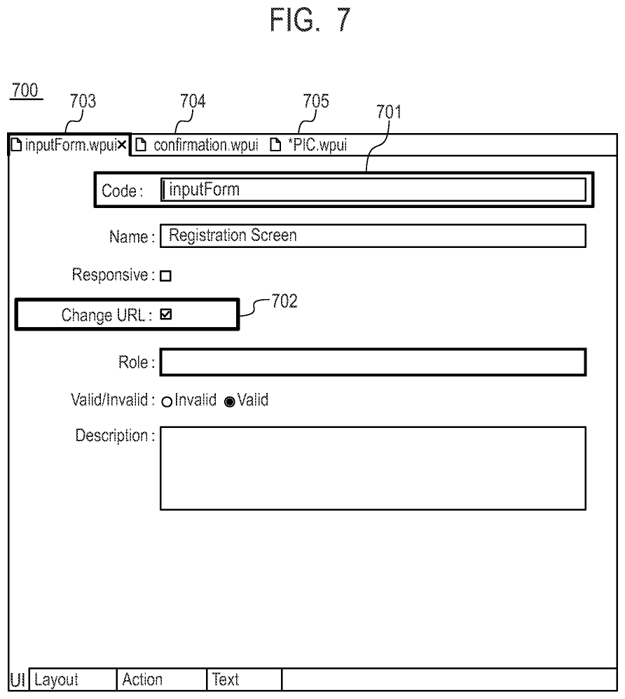

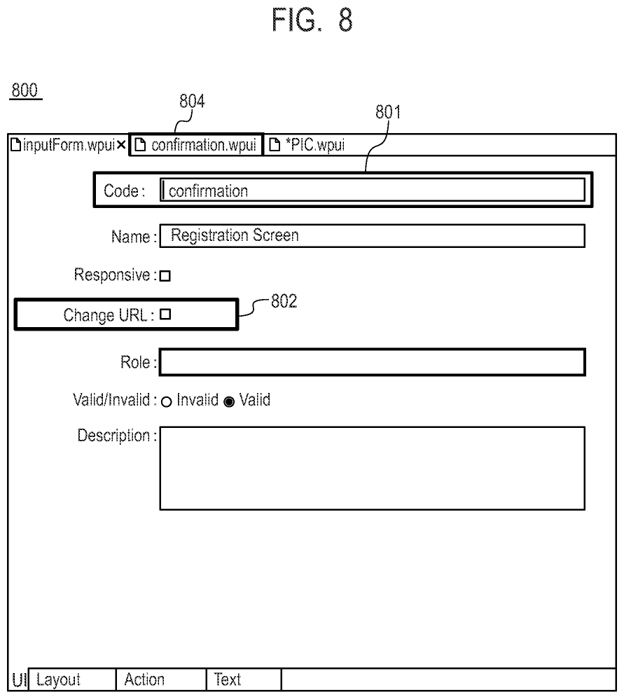

When transitioning the processing to Step S603, the CPU 201 in the program development device 101 reads one screen definition 402 of the application software into the RAM 202. A screen defining part of the read screen definition information is described with reference to FIG. 7 and FIG. 8.

FIG. 7 and FIG. 8 are examples of a screen display displayed on the output unit 210 according to the present embodiment; and a setting screen 700 in FIG. 7 and a setting screen 800 in FIG. 8 are examples of a setting screen for previously accepting user input before performing the flowchart in FIG. 5.

FIG. 7 and FIG. 8 are display examples of a screen being output by the output unit 210 in the program development device 101 and being displayed on a display of the program development device 101. Further, FIG. 7 and FIG. 8 are display examples of a setting screen for accepting a setting related to application software to be generated from a developer (a user of the program development device 101) in a development stage of the application software using the program development device 101.

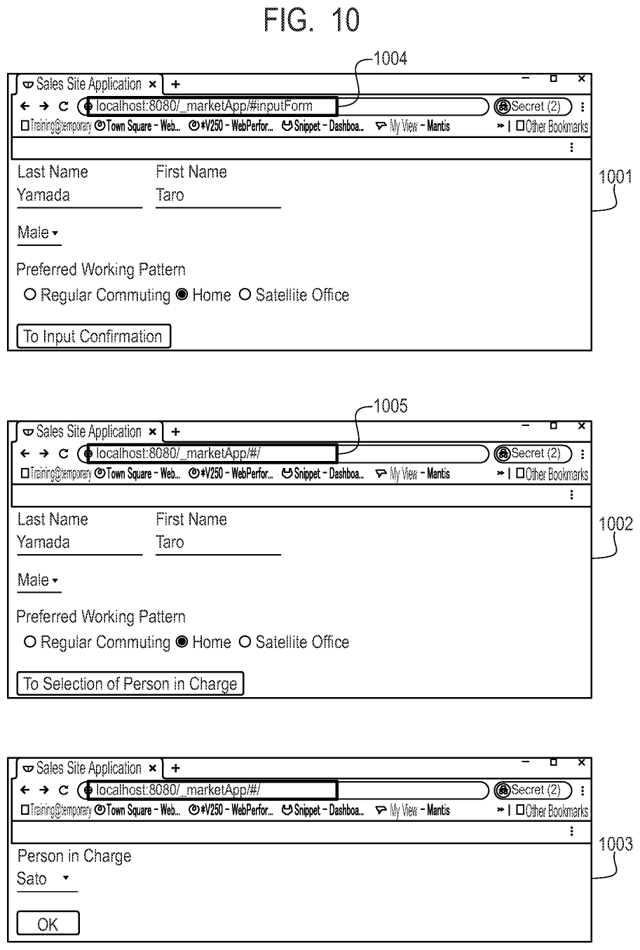

Further, FIG. 10 illustrates, as an input screen 1001, a confirmation screen 1002, and a selection screen 1003, display examples of a screen displayed on a display of the client PC 104 when application software generated by reflecting the content set on the screen in FIG. 7 is executed. In other words, each display example in FIG. 10 is a screen output to a user of the generated application software (a user of the client PC 104). Further, each display example in FIG. 10 is a display example being output by an output unit 214 in the client PC 104 and being displayed on the display of the client PC 104. FIG. 10 illustrates display examples in application software (the application software generated by the program development device 101) allowing a worker being a user of the client PC 104 to apply and register a working pattern of the worker. When the user (worker) inputs the name, the gender, and a working pattern of the user on the input screen 1001 (the input screen 1001 is an example of inputting “Taro Yamada,” “Male,” and “Home”) and clicks a button icon indicated as “To Input Confirmation,” the confirmation screen 1002 is displayed. The content input from the input screen 1001 is displayed on the confirmation screen 1002. When viewing the display content and confirming that there is no error in the input content, the user clicks a button icon indicating “To Selection of Person in Charge.” When there is an error in the input content, the user causes the input screen 1001 to be displayed again by operating a return button of the browser and corrects the input content. When the button icon indicating “To Selection of Person in Charge” is clicked on the confirmation screen 1002, the selection screen 1003 is displayed. The user selects a person in charge of approval (such as a superior of the user) on the selection screen 1003 and clicks an OK button. When the OK button is clicked, the content of application (the content input from the input screen 1001) is notified to the selected person in charge of approval, and the person in charge of approval can give approval. The application software assumes the operation as described above.

A setting screen 700 in FIG. 7 displayed by selecting a tab 703 is a setting screen related to the input screen 1001 in FIG. 10. A setting screen 800 in FIG. 8 displayed by selecting a tab 704 is a setting screen related to the confirmation screen 1002 in FIG. 10. A tab 705 is a tab for accepting an instruction for displaying a setting screen related to the selection screen 1003 in FIG. 10. In each setting screen, whether to present (output) a URI of a related screen out of screens displayed by to-be-generated application software to the user of the client PC 104 can be set.

Each of the tabs 703 to 705 is a tab for each screen of each piece of application software. The tab 703 is an example of part of a screen definition setting related to an input screen, the tab 704 is an example of a screen definition setting of a confirmation screen, and the tab 705 is an example of a screen definition setting of a selection screen. After the user makes a registration from an input screen “inputForm” related to the tab 703 (the input screen 1001 in FIG. 10), the application software being a setting target in the setting screen in FIG. 7 displays, to the user, “confirmation” being a confirmation screen for confirming correctness of the input item (the confirmation screen 1002 in FIG. 10) and being related to the tab 704. Subsequently, the application software displays “PIC” being a selection screen of a person in charge (the selection screen 1003 in FIG. 10) and being related to the tab 705. Each input-output item (the screen definition 402) in FIG. 10 is set by a user (a developer being a user of the program development device 101) before the flowchart in FIG. 5 is performed.

A detailed problem of the present embodiment is described.

For example, it is assumed in the application software being a definition target in FIG. 7 (as illustrated in FIG. 10) that the input screen 1001 being a setting target of the tab 703 transitions in a sequential order to the confirmation screen 1002 being a setting target of the tab 704 and the selection screen 1003 being a setting target of the tab 705. By performing routing setting in a single-page application, identification information (screen code) of a screen is provided for each screen and a direct transition to the corresponding screen can be made. For example, in the case of the confirmation screen 1002, specifying a URI “localhost:8080/_marketApp/#confirmation” allows direct transition to the confirmation screen 1002 when routing setting is performed. However, the confirmation screen 1002 (that is, a screen being a setting target of the tab 704) is a screen for confirming a value input to the input screen 1001 (that is, a screen being a setting target of the tab 703), and therefore directly inputting the aforementioned URI is meaningless. In other words, a single-page application including a screen on which routing setting is not desirable needs to be generated. The routing setting technology in a single-page application is a technology for association of a URI in order to make the application similar to a regular multi-page application, and generation of a screen on which routing setting is inhibited is not considered. The description returns to FIG. 7.

A code “inputForm” is input to a screen code input field 701 in the setting screen 700 displayed in the tab 703 selected in FIG. 7. While the value of the screen code input field 701 is related to the tab name of the tab 703, the tab 703 and the screen code input field 701 do not need to be the same; and when the tab name is different from the screen code, the two have only to be managed by data associating the two with each other or the like. The value input to the screen code input field 701 (a value being a character string at the end of the URI of a screen being a setting target) may have a tab name as an initial value, and the initial value may be changed by a user by inputting a character string.

A checkbox 702 is a checkbox (display item) causing a user to input a setting for whether to perform routing setting to a screen being a setting target (the input screen 1001) in a setting screen opened in FIG. 7 (in this case, the setting screen 700 displayed by specifying the tab 703). Since the screen (input screen) being a setting target in the tab 703 in the setting screen 700 is a screen to which a direct transition can be permitted, the checkbox 702 is checked. Specifically, the checkbox 702 is a display item for accepting an instruction about whether to provide identification information (URI) for a screen being displayed by application software to be generated and being a setting target.

The setting screen 800 in FIG. 8 is a setting screen displayed when the tab 804 (being the same as the tab 704 in FIG. 7 and being a tab for selecting the “confirmation” screen) is selected and displays an input screen for a screen definition setting of a confirmation screen. A screen code name “confirmation” is input to a screen code input field 801.

A checkbox 802 is a checkbox for causing a user to input a setting of whether to perform routing setting to a screen being a setting target in a tab opened in FIG. 8 (in this case, 804). Since the input confirmation screen being a setting target of the tab 804 in the setting screen 800 is a screen to which a direct transition is undesirable, the checkbox 802 is not checked. The description returns to the flowchart in FIG. 6.

By using the screen definition information read in Step S603 in FIG. 6, subsequent processing is executed.

In Step S604, the CPU 201 in the program development device 101 determines whether a screen code name of the screen definition information (a code name input to the screen code input field 701 or 801) read in Step S603 is unique. When the code name is unique, the CPU 201 transitions the processing to Step S606; and when the code name is not unique, the CPU 201 transitions the processing to Step S605, determines an error, and discontinues the application generation processing. Uniqueness of a screen code name is guaranteed by the conditional branch; and when routing setting is performed, a screen can be uniquely set to a URI.

When transitioning the processing to Step S606, the CPU 201 in the program development device 101 determines whether to perform routing setting in the screen definition information read in Step S603 (702 or 802). The CPU 201 transitions the processing to Step S607 when routing setting is performed (the checkbox is ON) and transitions the processing to Step S608 when routing setting is not performed (the checkbox is OFF).

When transitioning the processing to Step S607, the CPU 201 in the program development device 101 outputs a setting of the currently read screen definition to a routing setting file as “history:true.” An example of the output routing setting file is described with reference to FIG. 9.

FIG. 9 is a diagram illustrating an example of a routing setting file according to the embodiment of the present disclosure.

An element 901 in FIG. 9 is the content of the routing setting of the screen “inputForm” (input screen) set on the setting screen 700 in FIG. 7. Since the checkbox 702 is set to ON (checked) in the setting screen 700, a “history” parameter in a screen UI (in the case of a routing setting file 900, “inputForm” being a setting target of the setting screen 700) is “true,” and routing setting is executed. In other words, a URI is provided with identification information “inpurForm,” and rendering between the URI and the UI screen is performed.

On the other hand, when transitioning the processing to Step S608, the CPU 201 in the program development device 101 outputs a setting of the currently read screen definition to the routing setting file as “history:false.” An example of the output routing setting file is described with reference to FIG. 9.

An element 902 in FIG. 9 is the content of the routing setting of a screen “confirmation” (confirmation screen) set on the setting screen 800 in FIG. 8. Since the checkbox 802 is set to OFF (not checked) in the setting screen 800, the “history” parameter in the screen UI (in the case of the routing setting file 900, “confirmation” being a setting target in the setting screen 800) is “false,” and routing setting is not executed. In other words, rendering between a URI and a UI screen is not performed. The description returns to the flowchart in FIG. 6. A rendering relation between a URL and a UI screen is described with reference to FIG. 10.

Since routing setting is set to be executed in the input screen 1001 in FIG. 10 (in other words, the “history” parameter is “true,” similarly to 901) as is the case with the checkbox 702 in the setting screen 700, a URI is displayed as “localhost:8080/_marketApp/#inputForm” as indicated in an address bar 1004; and the URI allows a direct transition to the input screen in 1001. Further, the input screen 1001 can be bookmarked. Furthermore, a shortcut can be generated by copying the URI output to the address bar.

On the other hand, since routing setting is set to be not executed in the confirmation screen 1002 (in other words, the “history” parameter is “false,” similarly to 902) as is the case with the checkbox 802 in the setting screen 800, a URI is displayed as “localhost:8080/_marketApp/#/” as indicated in an address bar 1005; and the confirmation screen 1002 is not rendered with the URI. Even when a search is performed by copying a character string “localhost:8080/_marketApp/#/” displayed in the address bar 1005 and pasting the character string into a blank address bar, the confirmation screen 1002 is not displayed. In this case, an error indication or a top page of the generated single-page application is displayed. In other words, identification information for transition to the confirmation screen 1002 is not output to a user of the generated application software (a user of the client PC 104). Therefore, it is impossible to bookmark the confirmation screen 1002. Furthermore, it is also impossible to generate a shortcut to the confirmation screen 1002.

As described above, an effect that whether rendering between a URI and a UI screen is performed can be easily set for each screen is provided. Specifically, whether to correlate a URI with each of a plurality of screens displayed by generated application software (whether to perform output to a user of the generated application software) can be easily set by a simple operation of checking a checkbox.

In next Step S609, the CPU 201 in the program development device 101 branches the processing, based on whether another screen to be rendered exists. The CPU 201 returns the processing to Step S603 when another screen exists and ends the processing in the flowchart in FIG. 6 when another screen does not exist.

Through the processing described above, a mechanism for easily developing a single-page application can be provided.

Specifically, application software allowing coexistence of a page undergoing routing setting and a page not undergoing routing setting in a single-page application can be easily generated from a GUI, and an effect that even an engineer without a high level of skill can generate a single-page application is provided.

As described above, it goes without saying that the object of the present disclosure is achieved by supplying a recording medium recording a program achieving the functionalities according to the aforementioned embodiment to a system or a device and reading and executing the program stored in the recording medium by a computer (or a CPU or an MPU) in the system or the device.

In this case, the program itself read from the recording medium achieves a new functionality of the present disclosure, and therefore the recording medium recording the program constitutes the present disclosure.

Examples of a usable recording medium for supplying a program include a flexible disk, a hard disk, an optical disk, a magneto-optical disk, a CD-ROM, a CD-R, a DVD-ROM, a magnetic tape, a nonvolatile memory card, a ROM, an EEPROM, and a silicon disk.

Further, it goes without saying that, in addition to a case in which the functionalities according to the aforementioned embodiment are achieved by executing the read program by the computer, a case in which an operating system (OS) or the like operating on the computer performs actual processing in part or in whole in accordance with an instruction provided by the program and the functionalities according to the aforementioned embodiment are achieved by the processing is also included.

Furthermore, it goes without saying that a case in which, after the program read from the recording medium is written into a memory included in a function extension board inserted into the computer or a function extension unit connected to the computer, a CPU or the like included in the function extension board or the function extension unit performs actual processing in part or in whole in accordance with an instruction provided by the program code and the functionalities according to the aforementioned embodiment are achieved by the processing is also included.

Further, the present disclosure may be applied to a system configured with a plurality of pieces of equipment or may be applied to a device configured with a single piece of equipment. Further, it goes without saying that the present disclosure can adapt to a case of being achieved by supplying a program to the system or the device. In this case, the system or the device can be provided with the effects of the present disclosure by reading a recording medium storing a program for achieving the present disclosure into the system or the device.

The form of the aforementioned program may take a form of an object code, a program code executed by an interpreter, script data supplied to an operating system (OS), or the like.

Furthermore, the system or the device can be provided with the effects of the present disclosure by downloading and reading a program for achieving the present disclosure from a server, a database, or the like on a network by using a communication program. Note that every configuration acquired by combining the aforementioned embodiments and modified examples thereof is also included in the present disclosure.

The present disclosure can provide a mechanism for easily generating application software in which a screen to which a direct transition is allowed and a screen to which a direct transition is not allowed coexist.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions

This application claims the benefit of Japanese Patent Application No. 2021-008957, filed Jan. 22, 2021 and Japanese Patent Application No. 2021-192811, filed Nov. 29, 2021 which are hereby incorporated by reference herein in their entirety.

What is claimed is:

1. An information processing system comprising at least one memory and at least one processor which function as:
a display control unit configured to perform control to display a display item accepting an instruction about whether to provide identification information for a screen displayed by generated application software; and
a control unit configured to perform control to generate application software based on the instruction accepted for the display item,
wherein the control unit is operable to generate specific application software, and
wherein the specific application software is operable to display a first screen on which an instruction to provide identification information is accepted by the display item and a second screen on which an instruction to provide identification information is not accepted by the display item, and
wherein, when the specific application software is executed, the specific application software operates to output, to a user of the specific application software, identification information of the first screen for providing an instruction to display the first screen and not to output, to the user, identification information of the second screen for providing an instruction to display the second screen.

2. The information processing system according to claim 1, wherein the first screen is bookmarkable and the second screen is not bookmarkable.

3. The information processing system according to claim 1, wherein the second screen is a screen displayed when a specific operation is accepted on the first screen.

4. The information processing system according to claim 1, wherein the specific application software is a single-page application.

5. The information processing system according to claim 4, wherein the control unit is further configured to perform control not to perform processing based on the instruction accepted for the display item when generated application software is not a single-page application.

6. The information processing system according to claim 1, wherein the display control unit performs control to switch a display mode of the display item to an on-display mode or an off-display mode, based on an input to the display item.

7. The information processing system according to claim 1, wherein the identification information is a URI.

8. The information processing system according to claim 1, wherein identification information of the first screen is information displayed in an address bar of a browser when the first screen is displayed.

9. The information processing system according to claim 1, wherein the at least one memory and the at least one processor further function as a setting unit configured to set a value to be identification information of a screen displayed by generated application software, based on a value input from a user.

10. The information processing system according to claim 9,
wherein the at least one memory and the at least one processor further function as a determination unit configured to determine, for each of a plurality of screens displayed by generated application software, whether identification information set by the setting unit is unique relative to identification information of another screen, and,
wherein the control unit is further configured to perform control to discontinue generation of application software if identification information determined to be not unique by the determination unit exists.

11. The information processing system according to claim 1,
wherein the control unit is further configured to perform control to generate application software, based on screen definition information including input item definition information, output item definition information, and definition information of a layout of an item, each piece of information being set by a user, and
wherein the screen definition information is defined based on the instruction accepted for the display item.

12. A method for controlling an information processing system, the method comprising:
a display control step of performing control to display a display item accepting an instruction about whether to provide identification information for a screen displayed by generated application software; and
a control step of performing control to generate application software based on the instruction accepted for the display item,
wherein the control step is operable to generate specific application software, and
wherein the specific application software is operable to display a first screen on which an instruction to provide identification information is accepted by the display item and a second screen on which an instruction to provide identification information is not accepted by the display item, and
wherein, when the specific application software is executed, the specific application software operates to output, to a user of the specific application software, identification information of the first screen for providing an instruction to display the first screen and not to output, to the user, identification information of the second screen for providing an instruction to display the second screen.

13. A computer-readable storage medium storing a program for causing a computer to function as each unit in the information processing system according to claim 1.
